(19) United States
(12) Patent Application Publication
(10) Pub. No.: US 2008/0223041 A1
(43) Pub. Date: Sep. 18, 2008

(54) Geothermal canal with hydrostatic system for use in a geothermal power plant

(76) Inventor: J. David Reynolds, Florence, MA (US)

Correspondence Address: J. David Reynolds, 140 Pine Street # 11, Florence, MA, 01062, US

(21) Appl. No.: 11/900,743

(22) Filed: Sep. 13, 2007

Related U.S. Application Data
(60) Provisional application No. 60/918,757, filed on Mar. 17, 2007.

(51) Int. Cl. F03G 7/04

(52) U.S. Cl. 60/641.5

(57) ABSTRACT

A Geothermal Canal With Hydrostatic System for Use in a Geothermal Power Plant, providing an apparatus which collects heat from hot rocks located beneath the earth's surface and transfers the heat into water to be flashed into steam for the production of electricity. This invention is for use in all locations, including those with low sub-surface temperatures and those with no near-surface thermal reservoirs. This invention comprises (a) a Geothermal Canal which comprises (i) a vertical shaft or shafts, 10 feet in diameter, extending to a depth of at least 10,000 feet; (ii) a horizontal shaft or shafts, 10 feet in diameter, which extends from the vertical shaft or shafts and is at least 1,000 feet in length; and (iii) an intake grate; (b) a Hydrostatic System which equalizes the pressure in the Geothermal Canal, allows for independent control of the pressure in different areas of the Geothermal Canal, and allows objects and water to pass through the Geothermal Canal; (c) a Material Transfer System which allows material to be transported throughout the Geothermal Canal; (d) a Borehole System which extracts heat from surrounding, hot rock by driving water through hot rock either via a radiator-like system or via a hot fractured rock system; and (e) a Power Plant which flashes the heated water into steam and convert it into electricity.

### CROSS REFERENCE TO RELATED PATENT APPLICATION

This Inventor and this Invention hereby claim the benefit of provisional application Ser. No. 60/918,757, filed Mar. 17, 2007.

### REFERENCES CITED

U.S. PATENT DOCUMENTS

| | | |
|---|---|---|
| 4,223,729 | September 1980 | Foster |
| 4,776,169 | October 1988 | Coles, Jr. |
| 5,515,679 | May 1996 | Shulman |
| 7,059,131 | June 2006 | Hildebrand |

### BACKGROUND

Geothermal energy is energy stored in the earth's crust, deriving from “hot rock” and the natural fluids, primarily water, contained in the hot rock's fractures and pores. These fluids have been used for cooking and bathing since the beginning of recorded history. Industrial and commercial uses of geothermal energy were first developed in the early twentieth century. In 1904, electricity was first produced using geothermal steam in Lardello, Italy. The use of geothermal energy and methods of obtaining it have developed slowly but significantly since then.

The virtues of geothermal energy as a potential alternative energy source are clear: (a) geothermal power avoids the negative environmental impacts of coal, nuclear power, natural gas and hydropower, as most geothermal power plants produce no emissions, and as the only major by-product produced by most geothermal power plants is distilled water; (b) geothermal power reduces dependence on natural gas and foreign oil and is not subject to big price fluctuations; (c) existing geothermal facilities have not generated the political opposition associated with nuclear and wind power; (d) the source of geothermal power, unlike solar and wind, is continuous and predictable, and the fuel is free which provides inherent cost savings; and (e) geothermal power plants do not have the security drawbacks of other facilities, particularly nuclear facilities.

At present, over 20 countries produce geothermal electricity, with the United States in the lead. According to the United States Department of Energy, in 2005, 16,010 gigawatt hours of geothermal electricity were produced at 61 U.S. plants. Remarkably, this still accounts for only 0.36% of U.S. annual electricity generation. A key reason that research around, and development of, geothermal energy has been limited is the assumption that geothermal energy is only viable in certain locations with ideal geological conditions, such as where hot rock is close to the earth's surface and high rock porosity/permeability exists, or where there exists natural geysers or other naturally-heated bodies of water. In fact, many still consider geothermal energy an “exotic” resource, suitable only in places where steam is on or near the earth's surface (e.g. Iceland and the western United States). Moreover, research into methods and technologies to tap geothermal heat resources deeper beneath the earth's surface has not been encouraged by United States federal policy since the 1970s. However, with the recent energy crisis and the growing consensus on global warming, geothermal energy may be emerging as the more practical energy alternative.

New research on the feasibility of non-traditional sources of geothermal energy was conducted by a distinguished panel led by MIT Professor, Jefferson Tester, and published in January 2007, which is not admitted to be prior art with respect to the present invention by its mention in this Background section. This study found that new methods, using existing oil-drilling technologies, could stimulate and tap geothermal energy at much greater depths and under less ideal conditions than previously supposed. According to the findings of the panel, such “Enhanced Geothermal Systems” (hereinafter, “EGS”) have the potential to supply a significant amount of the United States' electricity. But unlike conventional plants, water would be the only fuel required. The findings of the MIT panel further suggest that EGS combined with more traditional methods could supply as much as 10% of U.S. energy needs by the year 2050. The MIT report indicates that geothermal energy production may now be possible in New England due to advances in drilling technology that allow for heat extraction to depths of up to 6 miles.

There are currently several methods and systems for collecting and producing geothermal energy, however, typical of most attempts is that they are practical for use only in geological regions where heat or hot rock is very close in proximity to the earth's surface, or where there exist natural geysers or other naturally-heated bodies of water available for use in the geothermal systems. Thus, they are not viable for use in regions that do not meet this strict criterion. Moreover, most methods and systems for collecting and producing geothermal energy typically do not utilize shafts or wells that are large in diameter, but instead utilize narrow shafts or wells; or utilize shafts or wells that do not or cannot extend to great depths beneath the earth's surface because they do not make use of a hydrostatic system that would allow for this.

What is needed is a Geothermal Canal with Hydrostatic System for Use in a Geothermal Power Plant which is capable of use in locations where sub-surface temperatures are low, where hot rocks rarely occur or do not occur close to the earth's surface, and where there are no known near-surface thermal reservoirs or other naturally-heated bodies of water; having a hydrostatic system which, among other things, maintains the structural integrity of a large Geothermal Canal at great depths.

### SUMMARY

The present invention satisfies the above needs. This invention provides an apparatus to collect heat from hot rock located beneath the earth's surface and to transfer this heat to water, which water will then be flashed into steam, and then converted into electricity. This invention is for use in all geographic locations, including those traditionally thought incapable of producing geothermal energy because of low sub-surface temperatures and/or the lack of near-surface reservoirs or other naturally-heated bodies of water.

A Geothermal Canal with Hydrostatic System for Use in a Geothermal Power Plant is provided, which comprises of: (1) a Geothermal Canal, which comprises of a vertical shaft or shafts extending to a depth of at least 10,000 feet, and a horizontal shaft or shafts at least 1,000 feet in length, with each shaft being at least 10 feet in diameter, and an intake grate; (2) a Hydrostatic System which equalizes pressure in the Geothermal Canal, which allows for independent control of the pressure in different areas of the Geothermal Canal, and which allows objects and water to pass throughout the Geothermal Canal, and which comprises of pumps, locks, doors, a high pressure line or lines, and pressure gauges; (3) a Material Transfer System to transport material throughout the Geothermal Canal, which comprises of a material transfer container, pumps, a slurry line or lines, and an autonomous movement component; (4) a Borehole System to collect heat from surrounding, hot rock, via either (a) a radiator-like system utilizing a plurality of boreholes that are drilled into the sides of the Geothermal Canal at intervals, and that are connected laterally by horizontal directional channels and by radiators that are placed on the inside wall of the Geothermal Canal, and that in this way, form a complete circulatory loop which extends the full length of the horizontal shaft or shafts of the Geothermal Canal, so that when water flows through the circulatory loop, the horizontal boreholes and horizontal directional channels collect heat from surrounding, hot rock and then transfer the heat to the radiators, which then transfer the heat to the water in the Geothermal Canal via thermal induction; or (b) a fractured rock system utilizing a plurality of horizontal boreholes that are drilled into the sides of the Geothermal Canal at intervals, and that are connected by surrounding, hot fractured rock so that water flows through the hot fractured rock, is heated, and then flows into the Geothermal Canal; and (5) a Power Plant or Plants which flashes heated water into steam for conversion into electricity. This invention provides the options of adding a water desalinization and/or waste-water treatment component.

### DRAWINGS

These and other features, aspects and advantages of this invention will become better understood with reference to the following description, appended claims, and accompanying drawings where:

FIG. 1. is a side view of the Geothermal Canal.

FIG. 2. is a side view of the Hydrostatic System.

FIG. 3. is a top view of the preferred embodiment of the Borehole System utilizing a radiator-like system.

FIG. 4. is a top view of an alternative embodiment of the Borehole System utilizing a fractured rock system.

### DESCRIPTION

This invention is a Geothermal Canal with Hydrostatic System for Use in a Geothermal Power Plant, comprising: (1) a Geothermal Canal; (2) a Hydrostatic System; (3) a Material Transfer System; (4) a Borehole System; and (5) a Power Plant.

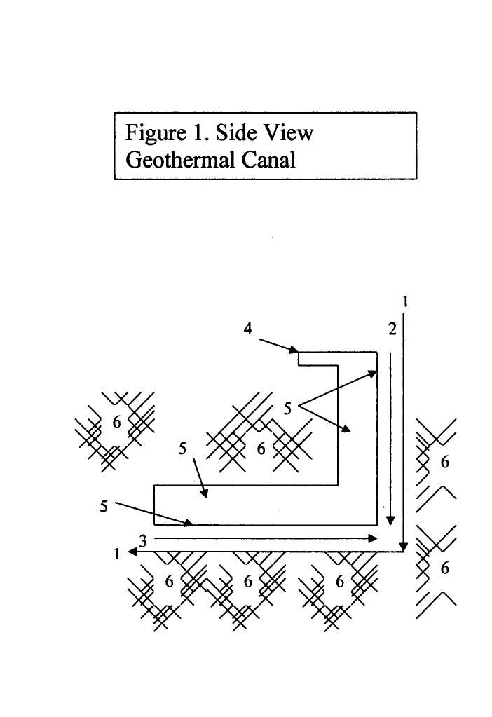

With reference to FIG. 1, the Geothermal Canal 1 initiates in a source of water and comprises a vertical shaft 2 which extends to a depth of at least 10,000 feet and a horizontal shaft 3 at least 1,000 feet in length which extends from the vertical shaft 2. Both the vertical shaft 2 and the horizontal shaft 3 are at least 10 feet in diameter. There is an option whereby more than one, or a series of, vertical shafts 2 and/or horizontal shafts 3 may be added. There is an intake grate 4 situated at the initiation of the Geothermal Canal 1 which prevents unwanted material from entering the system. The Geothermal Canal 1 is lined with a substance 5 that prevents and/or eliminates water seepage into the surrounding rock 6. The Geothermal Canal 1 facilitates the downward flow of water to depth of at least 10,000 feet and facilitates the return flow of heated water back to the earth's surface.

One of the advantages to having a Geothermal Canal 1 of such great depth is that it allows for the collection of heat from hot rock 6 located deep beneath the earth's surface, or not located near the earth's surface.

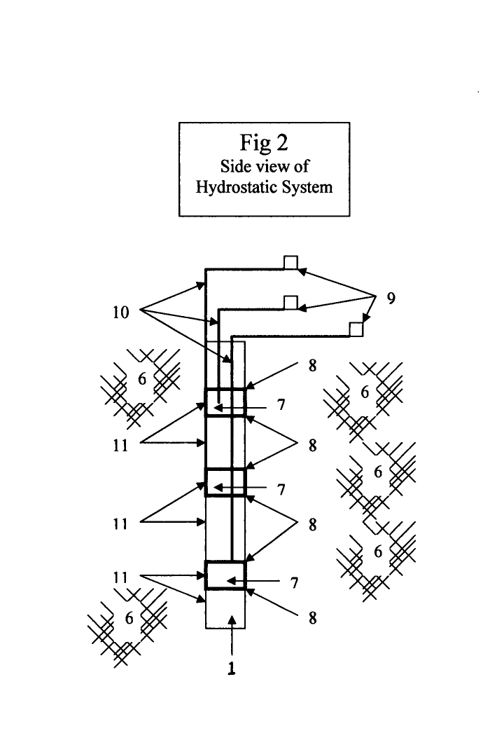

With reference to FIG. 2, The Hydrostatic System comprises: (i) a plurality of water-filled locks 7; (ii) a plurality of doors 8; (iii) a plurality of pumps 9; (iv) a high pressure line or a plurality of high pressure lines 10; and (v) a plurality of pressure gauges 11. The Hydrostatic System maintains the structural integrity of the Geothermal Canal 1 by balancing the internal pressure of the Geothermal Canal 1 with the external pressure of the surrounding rock 6, and allows for independent control of the pressure in different areas of the Geothermal Canal 1 and for varying the pressure in different areas of the Geothermal Canal 1, and allows objects and water to pass throughout the Geothermal Canal 1.

The water-filled locks 7 are located in various places throughout the Geothermal Canal 1 and move objects in and out of the Geothermal Canal 1 via a series of doors 8. The pumps 9 are located between the source of water and the location where the water is injected into the locks 7. The high pressure line or lines 10 connects the pumps 9 to the locks 7. The high pressure line or lines 10 runs along the side of the Geothermal Canal 1 and injects water that is driven down by the pumps 9 into the locks 7 in order to equalize the internal pressure of the Geothermal Canal 1 with that of the surrounding rock 6 and to maintain and manage constant pressure throughout the Geothermal Canal 1. The pressure gauges 11 are located in various places throughout the Geothermal Canal 1 and monitor the internal pressure of the Geothermal Canal 1. The pressure gauges 11 can be observed from the earth's surface, and may be used for detecting changes in pressure within the Geothermal Canal 1 which could indicate leaks in the Geothermal Canal 1. The pumps 9 work in conjunction with the locks 7 and the pressure gauges 11 to adjust and balance the pressure in the Geothermal Canal 1 and to equalize the pressure around the doors 8 to enable them to open easily. The pumps 9 may have built in shut off valves for when the pumps 9 are not in use. The pumps 9 may be run in reverse to produce power if pressure needs to be bled off.

One of the advantages to having a hydrostatic system, as described, is that it allows for the construction and use of a Geothermal Canal 1 of the described proportions and extending to the described depths, because it maintains the internal structural integrity of the Geothermal Canal 1 by balancing the internal pressure of the Geothermal Canal 1 with the external pressure of the surrounding rock. Another of the advantages to having a hydrostatic system, as described, is that it allows for independent control of the pressure in different areas of the Geothermal Canal 1 and for varying the pressure in different areas of the Geothermal Canal 1.

The Material Transfer System comprises: (i) one or a plurality of material transfer containers; (ii) a plurality of pumps; (iii) one or a plurality of slurry lines; and (iv) an autonomous movement component. The Material Transfer System is used to transport material, such as construction supplies, earth, waste, minerals and/or other objects, throughout the Geothermal Canal.

The material transfer container essentially consists of (i) a cargo compartment for carrying matter, material and/or supplies not able to be moved as slurry, (2) a plurality of high pressure tanks to allow for floatation, and (c) a buoyancy regulator to regulate the buoyancy of the material transfer container for efficient transportation of the material transfer container and materials throughout the Geothermal Canal. The material transfer container is transported through the Geothermal Canal using water flow controlled by a plurality of pumps which are located on the earth's surface. The pumps may have built in shut off valves for when the pumps are not in use. The pumps may be run in reverse to produce power, if needed. The slurry line or lines runs along side of the Geothermal Canal and operates as a reverse flow line to move small, particulate matter capable of transportation as slurry throughout the Geothermal Canal. An autonomous movement component located on the earth's surface remotely operates the Material Transfer System.

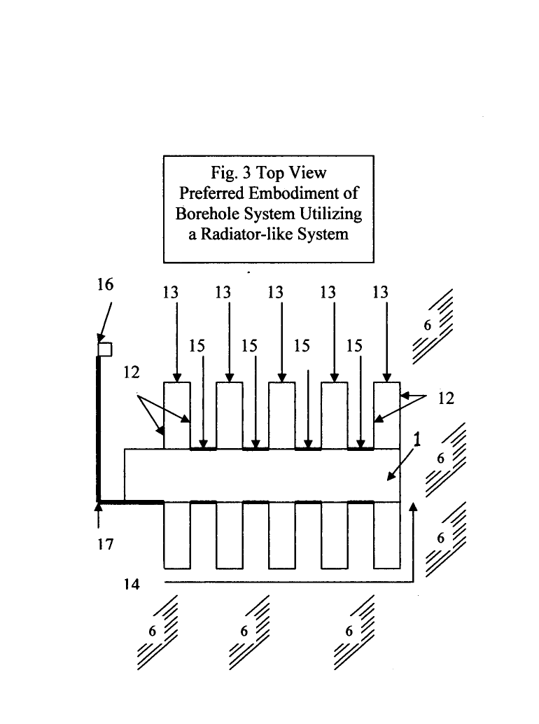

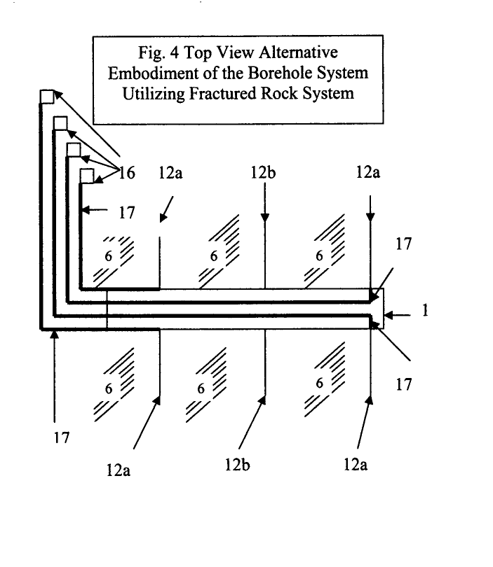

With reference to FIG. 3 and FIG. 4, the Borehole System has at least two embodiments. The preferred embodiment, as shown in FIG. 3, comprises horizontal boreholes 12, at least 4-inches in diameter and at least 1,500 in length, which are drilled into the sides of the Geothermal Canal 1 at least at every 20 foot interval and which are laterally connected by horizontal directional channels 13. A radiator 15 is placed between each horizontal borehole 12 on the inside wall of the Geothermal Canal 1 to transfer the heat collected from the horizontal boreholes 12 and horizontal directional channels 13. In this way, the horizontal boreholes, the horizontal directional channels and the radiators form a complete circulatory loop 14 which extends the full length of the horizontal shaft of the Geothermal Canal 1. A pump 16, located between the source of water and the location where the water is injected into the horizontal boreholes 12, drives the water down a high pressure line 17, which high pressure line 17 then injects the water into the first of the horizontal boreholes 12. Heat is thermodynamically transferred from the surrounding, hot rock 6 to this water as it travels through the first of the horizontal boreholes 12 and then into the first of the horizontal directional channels 13, then through the next of the horizontal boreholes 12 and then into the first of the radiators 15. The water travels in this way throughout the complete circulatory loop 14. This heated water transfers its heat into the Geothermal Canal's 1 greater water volume via the radiators 15. The pump 16 may have a built-in shut off valve for when the pump 16 is not in use. The pump 16 may be run in reverse to produce power if pressure needs to be bled off.

An alternative embodiment of the Borehole System, as shown in FIG. 4, comprises a plurality of horizontal boreholes 12a and 12b, at least 4-inches in diameter, which are drilled into the sides of the Geothermal Canal 1 at optimal intervals dictated by location, and to a length of at least 1,500 feet. The horizontal boreholes 12a and 12b are connected by surrounding, fractured rock 6. A plurality of pumps 16, located between the source of water and the location where the water is injected into the horizontal boreholes, drive water down a plurality of high pressure lines 17 and into a plurality of horizontal, input boreholes 12a which facilitate the flow of water through the hot fractured rock 6. A plurality of horizontal, return boreholes 12b, facilitate the flow of water from the fractured hot rock 6 into the Geothermal Canal 1. The fractured hot rock 6 heats the water which then enters the Geothermal Canal 1. The pumps 16 may have built in shut off valves for when the pumps 16 are not in use. The pumps 16 may be run in reverse to produce power if pressure needs to be bled off.

The Power Plant is located at the earth's surface and flashes the heated water into steam and converts the steam into electricity. More than one Power Plant may be added. A water desalinization component and/or a waste-water treatment component may be added.

Although this present invention has been described with reference to the preferred versions thereof, other versions are possible. Therefore, the spirit and scope of the appended claims should not be limited to the description of the preferred versions contained herein.

What is claimed is:

1. An apparatus for collecting heat from hot rocks located beneath the earth's surface and for transferring the heat to water, to be flashed into steam for production of electricity, which comprises:
(a) a Geothermal Canal, initiating in a source of water and lined with a substance that prevents and eliminates water seepage into surrounding rock, and which Geothermal Canal facilitates the downward flow of water to depth of at least 10,000 feet and then to a length of at least 1,000 feet and facilitates the return flow of heated water back to the earth's surface, comprising:
(i) a vertical shaft, at least 10 feet in diameter, which extends to a depth of at least 10,000 feet below the surface of the earth, and which is attached to a horizontal shaft;
(ii) a horizontal shaft, at least 10 feet in diameter, which extends from the vertical shaft, and which is at least 1,000 feet in length; and
(iii) an intake grate located at the Geothermal Canal's initiation which prevents unwanted material from entering the Geothermal Canal;
(b) a Hydrostatic System, which maintains the structural integrity of the Geothermal Canal by balancing the internal pressure of the Geothermal Canal with the external pressure of the surrounding rock, and which allows for independent control of the pressure and for varying the pressure in different areas of the Geothermal Canal, and which allows objects and water to pass throughout the Geothermal Canal, and which comprises:
(i) a plurality of water-filled locks which are located in various places within the Geothermal Canal, and which move objects in and out of the Geothermal Canal via a series of doors, and which locks work in conjunction with the pumps and pressure gauges to equalize the pressure around the doors so as to enable them to open easily;
(ii) a series of doors which are located in various places within the Geothermal Canal and which open and shut in order to allow material to pass thru the Geothermal Canal;
(iii) a plurality of pumps which are located between the source of water and the location where the water is injected into the locks, and which pumps work in conjunction with the locks and the pressure gauges to adjust and balance the pressure in the Geothermal Canal;
(iv) a high pressure line which runs along side of the Geothermal Canal, and which connects the pumps to the locks, so that the pumps drive water down the high pressure line and into the locks to adjust and equalize the internal pressure of the locks; and
(v) a plurality of pressure gauges which are located in various places throughout the Geothermal Canal and which monitor the internal pressure of the Geothermal Canal and which detect changes in pressure within the Geothermal Canal which could indicate leaks in the Geothermal Canal, and which can be observed from the earth's surface;
(c) a Material Transfer System, which transports material through the Geothermal Canal and which comprises:
(i) a material transfer container for transferring material not able to be moved as slurry through the Geothermal Canal, which comprises: (a) a cargo compartment for carrying material; (b) a plurality of high-pressure tanks to allow for the floatation of the material transfer container and materials; and (c) a buoyancy regulator to regulate the buoyancy of the material transfer container and materials, and to allow for the efficient transportation of the material transfer container and materials through the Geothermal Canal;
(ii) a plurality of pumps which are located on the earth's surface and are used to transport the material transfer container through the Geothermal Canal using water-flow;
(iii) a slurry line which runs along side of the Geothermal Canal and which operates as a reverse flow line to move small, particulate matter able to be moved as slurry through the Geothermal Canal; and
(iv) an autonomous movement component to remotely operate the Material Transfer System;
(d) a Borehole System which collects heat from surrounding, hot rock, and which is the preferred embodiment of the Borehole System, and which comprises:
(i) a plurality of horizontal boreholes, at least 4-inches in diameter and at least 1,500 in length, which are drilled into the sides of the Geothermal Canal at least at every 20 foot interval;
(ii) a plurality of horizontal directional channels which laterally connect the ends of the horizontal boreholes;
(iii) a plurality of radiators which are located between each horizontal borehole and on the inside wall of the Geothermal Canal, and which laterally connect the horizontal boreholes, such that the horizontal boreholes, horizontal directional channels, and the radiators form a complete circulatory loop which extends the full length of the horizontal shaft, and which radiators collect heat from the water in the horizontal boreholes and horizontal directional channels, and transfer the heat into the Geothermal Canal;
(iv) a pump which is located between the source of water and the location where the water is injected into the horizontal boreholes;
(v) a high pressure line which runs along side of the Geothermal Canal, and which connects the pump to the horizontal boreholes, so that the pump drives water down the high pressure line and into the horizontal boreholes for extraction of heat;
and
(e) a Power Plant located at the vertical shafts' initiation which flashes heated water into steam and which converts steam into electricity.

2. An apparatus as recited in claim 1 in which the Geothermal Canal has a plurality of vertical shafts.

3. An apparatus as recited in claim 1 or 2 in which the Geothermal Canal has a plurality of horizontal shafts.

4. An apparatus as recited in claim 1 in which the Hydrostatic System has a plurality of high pressure lines.

5. An apparatus as recited in claim 1 or 4 in which the pumps in the Hydrostatic System have built in shut off valves for when the pumps are not in use.

6. An apparatus as recited in claim 1 or 4 in which the pumps in the Hydrostatic System can be run in reverse to produce power if pressure needs to be bled off.

7. An apparatus as recited in claim 5 in which the pumps in the Hydrostatic System can be run in reverse to produce power if pressure needs to be bled off.

8. An apparatus as recited in claim 1 in which the Material Transfer System has a plurality of material transfer containers.

9. An apparatus as recited in claim 1 or 8 in which the Material Transfer System has a plurality of slurry lines.

10. An apparatus as recited in claim 1 or 8 in which the pumps in the Material Transfer System have built in shut off valves for when the pumps are not in use.

11. An apparatus as recited in claim 9 in which the pumps in the Material Transfer System have built in shut off valves for when the pumps are not in use.

12. An apparatus as recited in claim 1 or 8 or 11 in which the pumps in the Material Transfer System can be run in reverse to produce power, if needed.

13. An apparatus as recited in claim 9 in which the pumps in the Material Transfer System can be run in reverse to produce power, if needed.

14. An apparatus as recited in claim 10 in which the pumps in the Material Transfer System can be run in reverse to produce power, if needed.

15. An apparatus as recited in claim 1 in which the Borehole System's pump drives water into the high pressure line which injects the water into the first of the plurality of horizontal boreholes, which water then travels into the first of the plurality of horizontal directional channels, and then enters into the next of the plurality of horizontal boreholes, all the while collecting heat from the surrounding rock thermodynamically, and which water then enters into the first of the plurality of radiators, which radiator collects the heat from the water and transfers it to the Geothermal Canal's greater water volume, and in which the water travels in this way throughout the complete circulatory loop.

16. An apparatus as recited in claim 1 or 15 in which the Borehole System has a plurality of pumps.

17. An apparatus as recited in claim 1 or 15 in which the pump in the Borehole System has a built-in shut off valve for when the pump is not in use.

18. An apparatus as recited in claim 16 in which the pumps in the Borehole System have built in shut off valves for when the pumps are not in use.

19. An apparatus as recited in claim 1 or 15 in which the pump in the Borehole System can be run in reverse to produce power, if needed.

20. An apparatus as recited in claim 16 in which the pumps in the Borehole System can be run in reverse to produce power, if needed.

21. An apparatus as recited in claim 1, which is an alternative embodiment of the Borehole System, and which comprises:
(i) a plurality of pumps located between the source of water and the location where the water is injected into the horizontal input boreholes;
(ii) a plurality of high pressure lines which run along side of the Geothermal Canal, and which connect the pumps to the horizontal input boreholes, so that the pumps drive water down the high pressure lines and into the input boreholes;
(iii) a plurality of horizontal boreholes, at least 4-inches in diameter, which are drilled into the sides of the Geothermal Canal at optimal intervals as dictated by locale, to a length of at least 1,500 feet, and which are connected by surrounding, hot fractured rock;
(iv) a plurality of horizontal, input boreholes, which facilitate the flow of water from the high pressure lines through the hot fractured rock; and
(v) a plurality of horizontal, return boreholes, from which the heated water emerges and subsequently flows into the Geothermal Canal.

22. An apparatus as recited in claim 1 or 21 in which the pumps in the Borehole System have built in shut off valves for when the pumps are not in use.

23. An apparatus as recited in claim 1 or 21 in which the pumps in the Borehole System can be run in reverse to produce power, if needed.

24. An apparatus as recited in claim 22 in which the pumps in the Borehole System can be run in reverse to produce power, if needed.

25. An apparatus as recited in claim 1 in which the power plant includes water desalinization component.

26. An apparatus as recited in claim 1 or 25 in which the power plant includes a waste-water treatment component.

27. An apparatus as recited in claim 1 or 25 in which there is more than one power plant.

28. An apparatus as recited in claim 26 in which there is more than one power plant.
